(19) United States
(12) Patent Application Publication
(10) Pub. No.: US 2021/0302981 A1
(43) Pub. Date: Sep. 30, 2021

(54) PROACTIVE WAYPOINTS FOR ACCELERATING AUTONOMOUS VEHICLE TESTING

(71) Applicant: GM Cruise Holdings LLC, San Francisco, CA (US)

(72) Inventors: Alexander Hudson Case, San Francisco, CA (US); Robin Yang, Oakland, CA (US); Lucio Otavio Marchioro Rech, San Mateo, CA (US); Thomas Bachant, San Francisco, CA (US); Brian Joseph Donohue, San Francisco, CA (US); George Hines, Kensington, CA (US); Carlos Miguel Lasa, Union City, CA (US); Patrick John William Casey, San Francisco, CA (US)

(73) Assignee: GM Cruise Holdings LLC, San Francisco, CA (US)

(21) Appl. No.: 16/836,612

(22) Filed: Mar. 31, 2020

(51) Int. Cl. G05D 1/02; G05D 1/00; B60W 60/00

(52) U.S. Cl. CPC G05D 1/0221; G05D 1/0088; G01C 21/30; G05D 2201/0213; B60W 60/001

(57) ABSTRACT

Systems and methods are provided for accelerating autonomous vehicle testing. In particular, autonomous vehicle testing is accelerated by providing proactive waypoints. Systems and methods are provided for proactively seeking out times and locations in which an autonomous vehicle will most likely encounter on-road exposure of a particular set of variables. By increasing on-road exposure to a particular set of variables, an autonomous vehicle's response to the set of variables be more efficiently tested. According to various implementations, autonomous vehicles are automatically dispatched to routed to areas in which a test criteria frequently occurs, during particular times when the test criteria is likely to occur.

### FIELD OF THE DISCLOSURE

The present disclosure relates generally to autonomous vehicles (AVs) and to systems and methods for testing.

### BACKGROUND

Autonomous vehicles, also known as self-driving cars, driverless vehicles, and robotic vehicles, are vehicles that use multiple sensors to sense the environment and move without human input. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations. The vehicles can also be used to pick up packages and/or other goods and deliver the packages and/or goods to selected destinations.

Autonomous vehicles are frequently updated and the technology used to automatically direct the autonomous vehicles is tested to improve autonomous vehicle driving and safety. Testing includes exposing autonomous vehicles to various driving conditions, and evaluating each autonomous vehicle's response to selected conditions and events. In many instances, a vehicle's response to the selected conditions and events must be tested many times over.

### SUMMARY

Systems and methods are provided for accelerating autonomous vehicle testing. In particular, autonomous vehicle testing is accelerated by providing proactive waypoints. Systems and methods are provided for proactively seeking out times and locations in which an autonomous vehicle will most likely encounter on-road exposure to a particular set of variables. By increasing on-road exposure to a particular set of variables, an autonomous vehicle's response to the set of variables can be more efficiently tested. Systems and method are provided for determining where and when various events are likely to occur. According to various implementations, autonomous vehicles are automatically dispatched and routed to areas in which test criteria frequently occur, during particular times when the test criteria are likely to occur.

According to one aspect, a method for autonomous vehicle testing includes receiving a test request including at least one on-road event, determining a first location where the at least one on-road event is likely to occur, determining a timeframe during which the at least one on-road event is likely to occur at the first location, dispatching an autonomous vehicle to the first location during the timeframe, and recording any encounters of the at least one on-road event by the autonomous vehicle.

In various implementations, the 1 method further includes generating a route including the first location and directing the autonomous vehicle to follow the route. In some implementations, the method includes determining a second location where there at least one on-road event is likely to occur, and wherein the route includes the second location. In some implementations, the method includes directing the autonomous vehicle to repeat the route when the autonomous vehicle has completed the route.

In various implementations, determining the first location and determining the timeframe include consulting a high fidelity map. In some implementations, the method includes updating a high fidelity map with the encounters of the at least one on-road event. In some implementations, the method includes reviewing the encounters of the at least one on-road event and determining whether the encounters indicate an improvement. In some implementations, the method includes updating vehicle software when the encounters indicate an improvement. In some implementations, the method includes recording a total number of encounters. In some implementations, the method includes determining differences between the encounters.

According to one aspect, a system for autonomous vehicle testing includes a testing service for generating a test request including at least one on-road event, and a central computing system for receiving the test request, identifying a first location where the at least one on-road event is likely to occur, and dispatching at least one autonomous vehicle to perform the test request. The at least one autonomous vehicle is directed to the first location.

In various implementations, the central computing system comprises a routing coordinator for generating a route for the at least one autonomous vehicle. In some implementations, the generated route includes the first location. In some implementations, the central computing system includes a map having one or more layers. In some examples, map tiles include one or more layers of information. In various examples, layers include one or more of a base LiDAR map, semantic level features, and a prior information map. In one example, a prior information includes historical information as described herein. In some implementations, mapping information includes one or more of a 3-dimensional map, 2-dimensional rasterized tiles, and semantic information. In some implementations, the central computing system includes a 3-dimensional map, and the 3-dimensional map includes a layer indicating a likelihood of a future on-road event in areas in the 3-dimensional map. In some implementations, the layer indicates timeframes for the likelihood of the future on-road events, wherein the likelihood varies in different timeframes. In some implementations, the central computing system receives feedback from the at least one autonomous vehicle including any encounters of the at least one on-road event.

According to one aspect, a method for updating map information includes collecting data from a plurality of autonomous vehicles, wherein the data includes a first set of on-road events, transmitting the data to a central computing system, wherein the central computing system includes a 3-dimensional map, and generating a layer of the 3-dimensional map including the data.

In various implementations, collecting data includes identifying occurrences of on-road events in the first set of on-road events, and recording a location and a timeframe of each on-road event in the first set of on-road events. In some implementations, the timeframe includes a day of week and a time of the day. In some implementations, generating the layer of the 3-dimensional map includes indicating in the layer a likelihood of a future on-road event in areas in the 3-dimensional map.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a diagram illustrating an autonomous vehicle, according to some embodiments of the disclosure;

FIG. 2 is a flow chart illustrating a method for accelerating autonomous vehicle testing, according to some embodiments of the disclosure;

FIG. 3 is a diagram illustrating a testing service and a fleet of autonomous vehicles, according to some embodiments of the disclosure;

FIG. 4 is a flow chart illustrating a method of testing events in an autonomous vehicle, according to some embodiments of the disclosure;

FIG. 5 is a flow chart illustrating a method of updating autonomous vehicle software, according to some embodiments of the disclosure;

FIG. 6 is a flow chart illustrating a method of updating map information, according to some embodiments of the disclosure; and

FIG. 7 shows an example embodiment of a system for implementing certain aspects of the present technology.

### DETAILED DESCRIPTION

Overview

Systems and methods are provided for accelerating autonomous vehicle testing. In particular, systems and methods are provided for identifying and cataloging on-road events by location and timeframe (time of day, day of week). Additionally, systems and methods are provided for dispatching and routing autonomous vehicles to environments that are difficult for autonomous vehicles to drive in. In particular, autonomous vehicle testing is accelerated by providing proactive waypoints, and seeking out the proactive waypoints during testing. The proactive waypoints include times and locations in which an autonomous vehicle will likely encounter on-road exposure to a particular set of variables. By increasing on-road exposure to a particular set of variables, an autonomous vehicle's response to the set of variables can be more efficiently tested. For example, if a testing protocol requests 100 autonomous vehicle encounters with a particular set of variables (or a particular event), selecting a route that maximizes potential exposure to the set of variables allows the testing protocol to be completed more quickly, increasing efficiency of the testing.

Autonomous vehicles are frequently updated with new technology and algorithms. In one example, new software is submitted for testing on the road. The submission includes a testing request with details used to determine how to direct the autonomous vehicles to complete the test. For example, a submission may include a request to complete 100 left turns with the new software configuration. Updates are tested in real-world scenarios by directing the vehicle to drive around selected routes. When driving on a road, the autonomous vehicle encounters predicted events, such as oncoming traffic and left-hand turns, and unpredicted events, such as an animal in the road, or a car stopping short in front of the autonomous vehicle. Autonomous vehicles are tested to determine actual response to various events.

High fidelity maps are used for routing and directing autonomous vehicles and can include layers of information in addition to roadway maps. The layers of information can include, for example, expected traffic patterns and/or traffic density at various times of day and on various days of the week. When autonomous vehicles travel around an area, the autonomous vehicles record and provide feedback on events that are encountered, including where and when the events are encountered. The high fidelity maps can include a layer marking waypoints for both predictable and unpredictable events. Predictable events include route-specific events (e.g., an unprotected left turn) while unpredictable events can occur anywhere (e.g., an animal jumping out in front of the vehicle). The layer (or another layer) can mark waypoints or areas where unpredictable events more frequently occur, including a likelihood of occurrence of the event. The likelihood of unpredictable events along certain routes or in selected locations can be determined with analysis of data from previous autonomous vehicle routes. Data analysis from previous autonomous vehicle routes can also determine timeframes during which selected events are more likely to occur in selected locations and these locations and times can be included as identified waypoints for test vehicle routing.

Current systems for vehicle testing include manual entry of routes and/or waypoints. According to various implementations, systems and method are provided to automatically generate routes for autonomous vehicle testing of selected events, including identified waypoints for selected events for test vehicle routing. Autonomous vehicles are dispatched and routed to areas in which test criteria frequently occurs, during timeframes when the test criteria are likely to occur.

According to various implementations, the autonomous vehicles to be used for a selected testing protocol are determined based on the hardware and/or software configuration of the vehicles. In some implementations, the autonomous vehicles to be used for a selected testing protocol are identified based on each vehicle's current location and predetermined vehicle schedule constraints. A few examples of predetermined vehicle schedule constraints include charging schedules, maintenance schedules, and autonomous vehicle test operator break schedules.

According to some implementations, a test request includes a testing protocol in which the testing vehicle must be in a specific lane or complete a specific maneuver type. In some examples, to comply with these types of testing protocols, custom router weightings can be generated, wherein the weightings bias a vehicle to drive in certain lanes or complete certain maneuvers.

In some implementations, custom dispatching and routing logic are generated and associated with a specific autonomous vehicle. The autonomous vehicle is paired with a specific test to increase the likelihood that the autonomous vehicle achieves the desired exposure.

According to various implementations, using identified waypoints to automatically generate testing vehicle routes increases test efficiency by more quickly gathering data to meet the demands of a test. The automatically generated testing routes include locations where the testing vehicles are more likely to encounter selected events; the autonomous vehicles are given routes that map to desired events and/or maneuvers. In some examples, each time a vehicle encounters a desired event and/or maneuver, data about the vehicle's response to the desired event and/or maneuver is collected. In some examples, a vehicle or a fleet of vehicles are instructed to collect a selected number of samples, after which a selected test is considered complete, and the vehicle or vehicles is routed elsewhere. Vehicle testing using routes generated to increase event encounters can complete testing more quickly and efficiently, allowing for increased use of each vehicle.

### Example Autonomous Vehicle Configured for Accelerated Testing

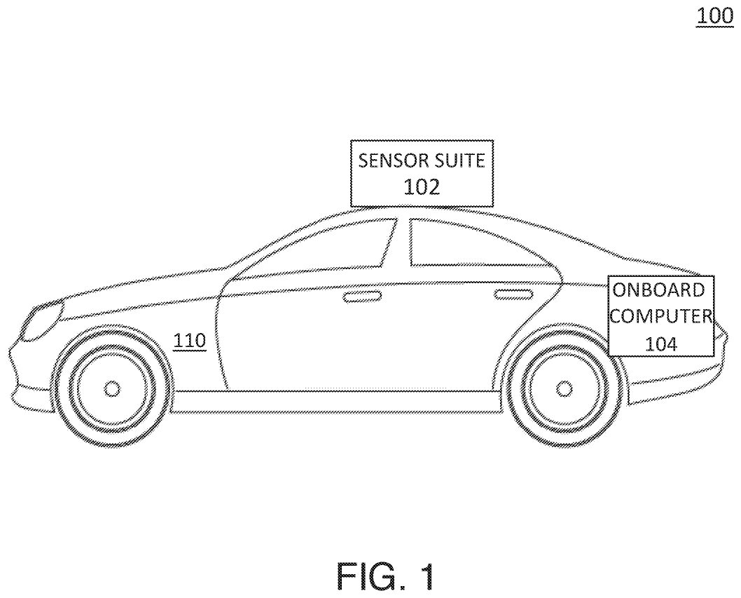

FIG. 1 is a diagram 100 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, and to sense and avoid obstacles. According to various implementations, the autonomous vehicle 110 is a testing vehicle. A testing vehicle drives around testing selected test criteria and test events. According to systems and methods of the disclosure, the autonomous vehicle 110 is directed to one or more identified waypoints and/or receives specific routes to travel to increase the likelihood of encountering various test criteria.

The sensor suite 102 includes localization and driving sensors. For example, the sensor suite may include one or more of photodetectors, cameras, RADAR, SONAR, LIDAR, GPS, inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment and, in some examples, sensor suite 102 data is used to detect selected events and/or testing variables, and update a high fidelity map. In particular, data from the sensor suite can be used to update a high fidelity map with information used to develop layers with waypoints identifying selected events, the locations of the encountered events, and the frequency with which the events are encountered at the identified location. In this way, sensor suite 102 data from many autonomous vehicles can continually provide feedback to the mapping system and the high fidelity map can be updated as more and more information is gathered.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point-cloud of the region intended to scan. In still further examples, the sensor suite 102 includes RADARs implemented using scanning RADARs with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some implementations described herein, the autonomous vehicle 110 includes sensors inside the vehicle. Based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface) and/or other interested parties (e.g., via a vehicle coordinator or a remote expert interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences. In some examples, the autonomous vehicle 110 is a testing vehicle and the vehicle passenger directs and/or updates the vehicle 110 to maximize autonomous vehicle encounters with test events.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

### Example Method for Accelerating AV Testing

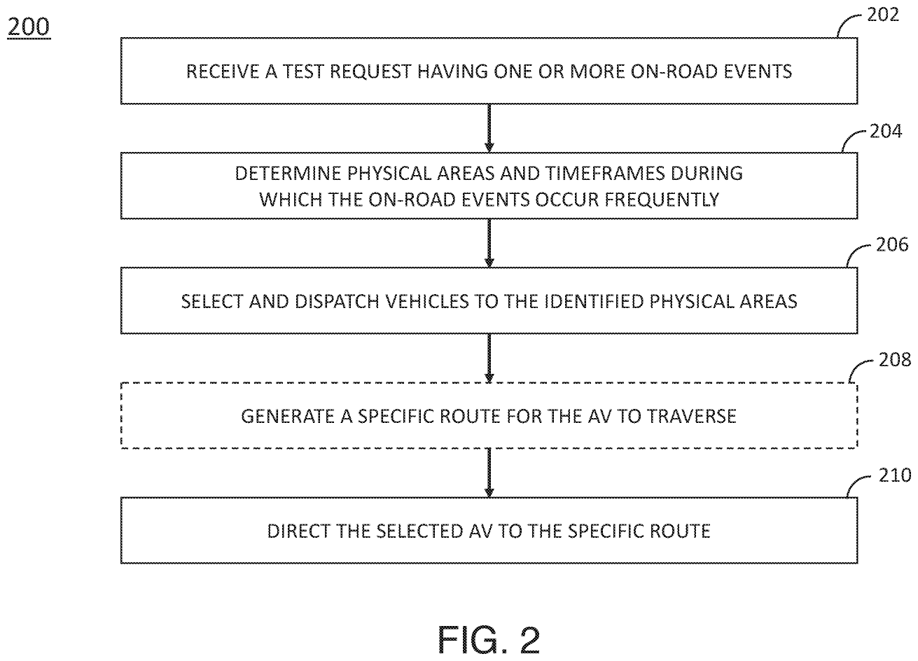

FIG. 2 is a diagram illustrating a method 200 for accelerating autonomous vehicle testing, according to various embodiments of the invention. At step 202, a test request is received. The test request includes one or more on-road events to be tested. In a few examples, on-road events include unprotected left-hand turns, presence of an emergency vehicle, being cut off by another vehicle, and a pedestrian stepping into the road in front of the vehicle.

At step 204, physical areas and timeframes during which the on-road events frequently occur are determined. In some implementations, a route coordinator for an autonomous vehicle fleet generates one or more test routes for maximizing likelihood of encountering the on-road events. In various examples, the routing coordinator uses a semantic layer of a map to determine the route(s). A 3-dimensional map includes multiple layers of information, with each layer including a different type of information for each area of the map. For example, one layer includes information about traffic in each location at various times of day and days of the week. In some examples, one layer of the 3-dimensional map includes information about selected events and the likelihood of each event occurring in each area of the map at various times of day.

In some examples, the selected events being tested are geographically static, such as unprotected left-hand turns. Other selected events are not static, such as likelihood of encountering an emergency vehicle (e.g., police car, ambulance, and/or firetruck). However, even non-static events may be predictably encountered more frequently in certain areas. For example, the likelihood of encountering an ambulance may increase near a hospital depot. Similarly, the likelihood of encountering a fire truck may increase near a fire station. In various examples, layers on the 3-dimensional map that indicate likelihood of encountering various events are generated based on data collected over time from autonomous vehicles on the road encountering the events.

At step 206, vehicles are selected and for dispatch to the identified physical areas. In some implementations, the selected autonomous vehicles are given waypoints in the identified physical areas and self-direct to the proactive waypoints. Optionally, at step 208, a specific route including the identified waypoints is generated for the autonomous vehicle to traverse. In various examples, the routing coordinator generates a specific route including physical areas for the autonomous vehicle to traverse during the identified timeframe. In some examples, the autonomous vehicle repeats the specific route multiple times during the determined timeframe. In various examples, the vehicles are each assigned a designated route by the routing coordinator. The routing coordinator determines the routes based on likelihood of encountering the selected event along the route. In some examples, two or more testing vehicles are assigned identical routes. In other examples, each testing vehicle is assigned a unique route. At step 210, the selected autonomous vehicle is directed to the specific route.

### Example of an AV Testing System

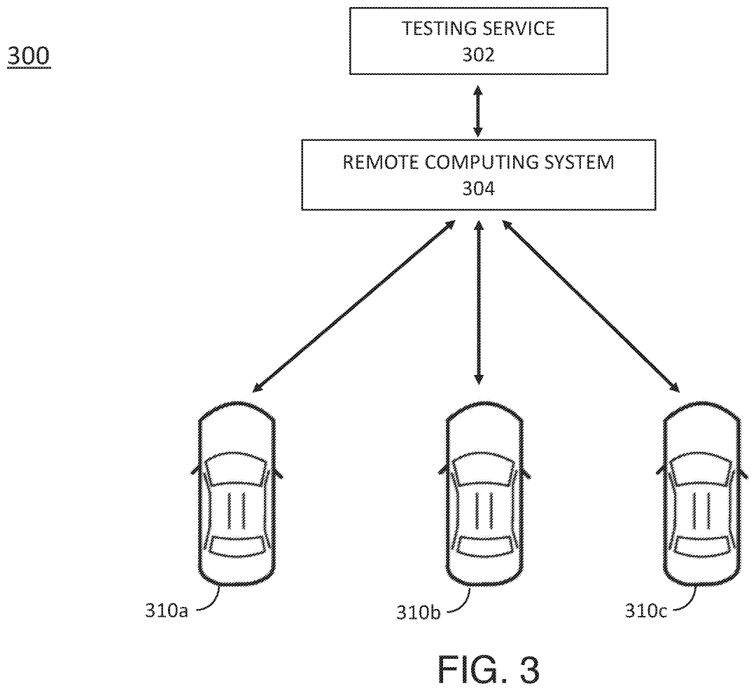

FIG. 3 is a diagram illustrating a testing service 302, a remote computing system 304, and a fleet of autonomous vehicles 310a-310c, according to some embodiments of the disclosure. The testing service 302 includes various testing instructions. In one example, the testing service 302 has a list of events to be tested. In some implementations, new software is installed on the vehicles 310a-310c and the testing service 302 arranges tests of functioning of the selected vehicles 310a-310c with respect to selected events. The testing service 302 communicates testing instructions including test events to the remote computing system 304.

In some examples, a central dispatch, such as a central computer or a remote computing system 304, receives testing instructions from the testing service. The remote computing system 304 accesses maps including information about areas and/or waypoints with a high likelihood of encountering selected testing events in the testing instructions. Additionally, in some examples, the remote computing system 304 identifies the vehicles that include the software to be tested. The remote computing system 304 selects one or more vehicles 310a-310c for testing. In some examples, the vehicles are selected based on the current location of the vehicle. For example, a vehicle that is close to a waypoint with a high likelihood of encountering a testing event may be selected for testing the event.

Using maps that include the testing event waypoint information, the remote computing system 304 generates a route for one or more vehicles 310a-310c. In some examples, the remote computing system 304 sends target waypoints to an autonomous vehicle onboard computer, and the onboard computer navigates to the waypoints. In some implementations, the remote computing system 304 includes a routing coordinator for planning a route for each selected autonomous vehicle 310a-310c, and the routing coordinator determines a route for the autonomous vehicle 310a-310c to travel from the autonomous vehicle's current location to a first waypoint, or to a selected area. In some examples, the route includes several target waypoints and/or target areas. In some examples, the route includes an iterative component, such that once the selected vehicle 310a-310c travels to all the target end points and/or target areas, the vehicle 310a-310c returns to the first target end point and/or target area visited and repeats the route to any subsequent target end points and/or target areas. According to various implementations, the selected test route is periodically updated.

In some examples, the autonomous vehicle 310a-310c repeats a testing route a predetermined number of times. In some examples, the autonomous vehicle 310a-310c repeats a testing route iteratively for a predetermined period of time. In some examples, the autonomous vehicle 310a-310c repeats a testing route until it has encountered a testing target event a predetermined number of times. In some examples, a fleet of autonomous vehicles 310a-310c are all testing a selected event, and each of the fleet of autonomous vehicles 310a-310c repeats its respective testing route until the fleet as a whole has encountered a testing target event a predetermined number of times. According to various examples, one or more of the autonomous vehicles 310a-310c provide feedback to the remote computing system including whether a test event was encountered at a target waypoint or in a target area.

### Example of an AV Testing Method

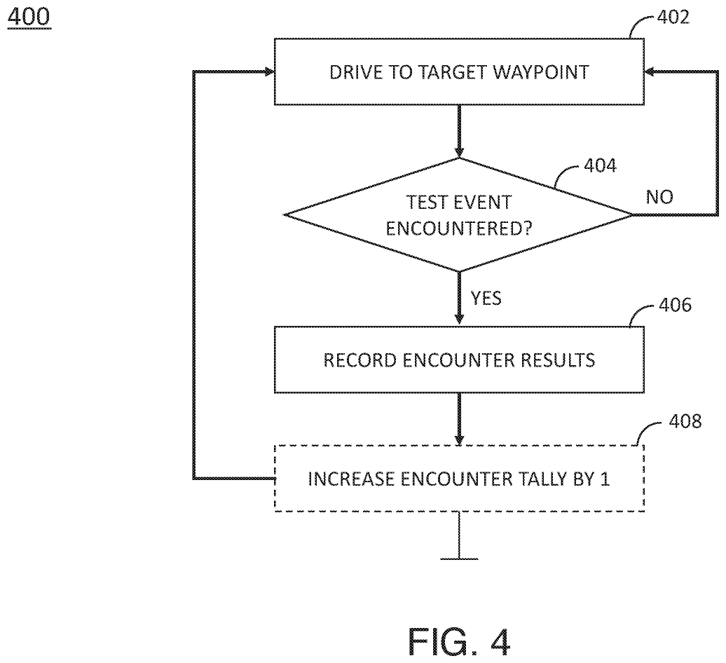

FIG. 4 is a flow chart illustrating a method 400 of testing events in an autonomous vehicle, according to some embodiments of the disclosure. In various implementations, an autonomous vehicle performs the method 400 after receiving a set of waypoints from a remote computing system, such as the remote computing system 304 of FIG. 3. At step 402, the autonomous vehicle drives to a target waypoint. At step 404, the vehicle determines whether the test event was encountered at the target waypoint. If the target event is not encountered, the autonomous vehicle returns to step 402 and drives to a next target waypoint. In some examples, if the target event it not encountered at the waypoint, the autonomous vehicle returns to the same target waypoint.

If the target event is encountered at the waypoint, at step 406, the encounter is recorded and tagged to identify a target event encounter. In some examples, the recorded encounter is transmitted to a cloud or to the remote computing system. In other examples, the recorded encounter is stored locally on the onboard computer. Optionally, in some examples, the autonomous vehicle counts how many times it encounters a test event, and at step 408, the autonomous vehicle increases the tally by one. The method 400 then returns to step 402, and the autonomous vehicle drives to a next target waypoint.

### Example of a Method for Updating AV Software

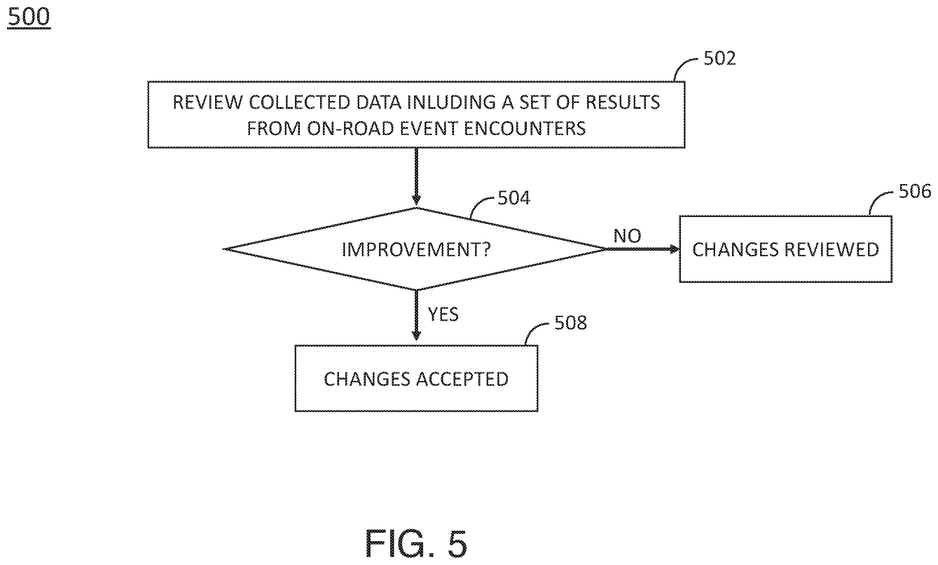

FIG. 5 is a flow chart illustrating a method 500 of updating autonomous vehicle software, according to some embodiments of the disclosure. At step 502, testing data collected from one or more autonomous vehicle testing runs is reviewed. In various examples, the autonomous vehicle(s) used for testing have an updated software component for addressing vehicle reaction to the target test events. The collected data includes at least one set of results of on-road event encounters from a testing vehicle.

Using the on-road event encounters, at step 504, it is determined whether the encounters represent an improvement over previous encounters of the same (or similar) test events. According to various implementations, a minimum number of event encounters is used to make improvement determinations. If the encounters indicate an improvement over previous autonomous vehicle actions with respect to the testing events, the updated software component is accepted at step 508 and installed in the autonomous vehicle. In some examples, the updated software component is accepted and installed in multiple autonomous vehicles, and in some examples, the updated software component is installed in a fleet of autonomous vehicles.

If the encounters do not indicate an improvement over previous autonomous vehicle actions with respect to the testing events, the updated software component is tagged for further review at step 506. The autonomous vehicle encounters are reviewed to determine differences in autonomous vehicle actions and reactions with respect to the test event, and to decide whether the differences are preferable. In some examples, the different actions/reactions are not preferable, and the updated software is simply discarded. In other examples, the differences are preferable and the updated software is kept. In some examples, the updated software is further updated and testing is repeated. In some examples, the autonomous vehicle actions and reactions with respect to the test event are not different, but the software component itself is preferable—for example, if the updated software component is more efficient. Thus, while the improvement at step 504 may be improved driving performance, it can also be improved functioning of the autonomous vehicle.

In some implementations, an autonomous vehicle performs event testing in between services provided as part of a ride share service and/or services provided as part of a peer-to-peer delivery network.

### Example of a Method for Updating Map Information

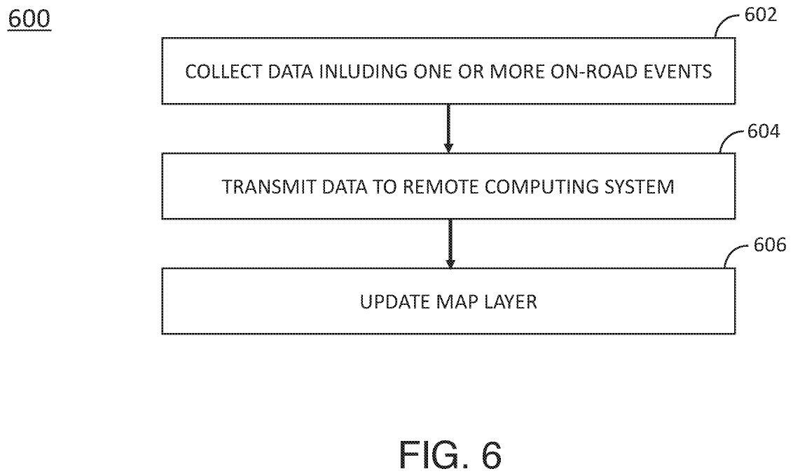

FIG. 6 is a flow chart illustrating a method 600 of updating map information, according to some embodiments of the disclosure. At step 602, data including one or more on-road events is collected. In a few examples, on-road events include left-turns, unprotected left-turns, a bicycle in the driving lane, a car stopping short in front of the vehicle, and an emergency vehicle passing the autonomous vehicle. There are many different types of on-road events that can be collected as autonomous vehicles drive around various routes. In some examples, autonomous vehicles are constantly collecting on-road event data. In some examples, the autonomous vehicles are performing testing routes, and specifically seeking out selected on-road events. At step 604, collected data on the on-road events is transmitted to a remote computing system. In some examples, the collected data is transmitted while the vehicle is on the road. In other examples, the collected data is uploaded when the vehicle returns to a service center or charging center. At step 606, the remote computing system uses the collected data to update its map. In particular, the map includes one or more layers indicating waypoints where selected events frequently occur, and timeframes indicating when those events frequently occur. The remote computing system uses the collected data to update the map layers for the respective events.

### Example of a Computing System for Vehicle Testing

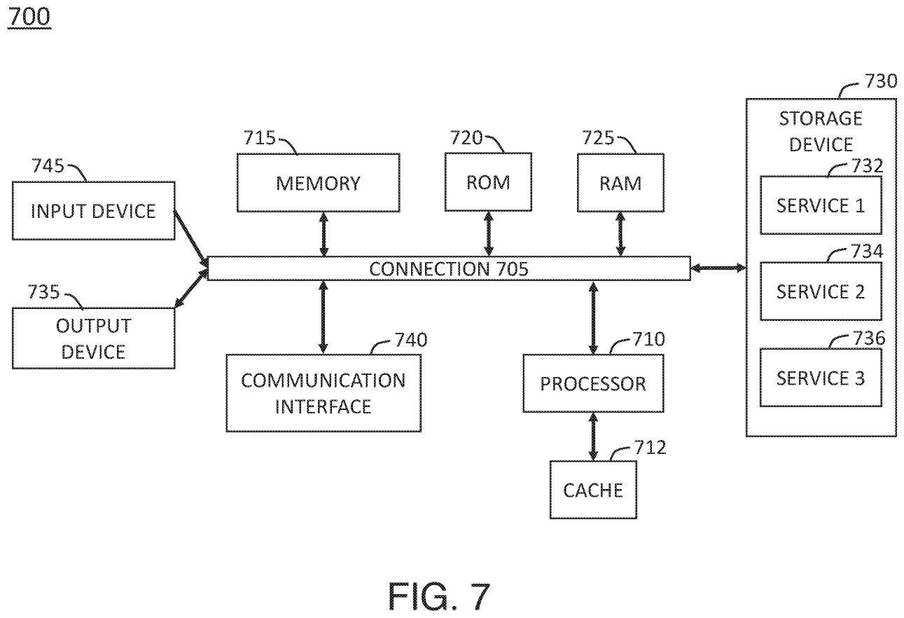

FIG. 7 shows an example embodiment of a computing system 700 for implementing certain aspects of the present technology. In various examples, the computing system 700 can be any computing device making up the onboard computer 104, the remote computing system 304, or any other computing system described herein. The computing system 700 can include any component of a computing system described herein which the components of the system are in communication with each other using connection 705. The connection 705 can be a physical connection via a bus, or a direct connection into processor 710, such as in a chipset architecture. The connection 705 can also be a virtual connection, networked connection, or logical connection.

In some implementations, the computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

The example system 700 includes at least one processing unit (CPU or processor) 710 and a connection 705 that couples various system components including system memory 715, such as read-only memory (ROM) 720 and random access memory (RAM) 725 to processor 710. The computing system 700 can include a cache of high-speed memory 712 connected directly with, in close proximity to, or integrated as part of the processor 710.

The processor 710 can include any general-purpose processor and a hardware service or software service, such as services 732, 734, and 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction, the computing system 700 includes an input device 745, which can represent any number of input mechanisms, such as a microphone for speech, a touch-sensitive screen for gesture or graphical input, keyboard, mouse, motion input, speech, etc. The computing system 700 can also include an output device 735, which can be one or more of a number of output mechanisms known to those of skill in the art. In some instances, multimodal systems can enable a user to provide multiple types of input/output to communicate with the computing system 700. The computing system 700 can include a communications interface 740, which can generally govern and manage the user input and system output. There is no restriction on operating on any particular hardware arrangement, and therefore the basic features here may easily be substituted for improved hardware or firmware arrangements as they are developed.

A storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as a processor 710, a connection 705, an output device 735, etc., to carry out the function.

As discussed above, each vehicle in a fleet of vehicles communicates with a routing coordinator. When a vehicle is flagged for service, the routing coordinator schedules the vehicle for service and routes the vehicle to the service center. When the vehicle is flagged for maintenance, a level of importance or immediacy of the service can be included. As such, service with a low level of immediacy will be scheduled at a convenient time for the vehicle and for the fleet of vehicles to minimize vehicle downtime and to minimize the number of vehicles removed from service at any given time. In some examples, the service is performed as part of a regularly-scheduled service. Service with a high level of immediacy may require removing vehicles from service despite an active need for the vehicles.

Routing goals may be specific or general in terms of both the vehicles they are applied to and over what timeframe they are applied. As an example of routing goal specificity in vehicles, a routing goal may apply only to a specific vehicle, or to all vehicles of a specific type, etc. Routing goal timeframe may affect both when the goal is applied (e.g., urgency of the goal, or, some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

In various implementations, the routing coordinator is a remote server or a distributed computing system connected to the autonomous vehicles via an internet connection. In some implementations, the routing coordinator is any suitable computing system. In some examples, the routing coordinator is a collection of autonomous vehicle computers working as a distributed system.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### Select Examples

Example 1 provides a method for autonomous vehicle testing, comprising receiving a test request including at least one on-road event, determining a first location where the at least one on-road event is likely to occur, determining a timeframe during which the at least one on-road event is likely to occur at the first location, dispatching an autonomous vehicle to the first location during the timeframe, and recording any encounters of the at least one on-road event by the autonomous vehicle.

Example 2 provides a method according to example 1, further comprising generating a route including the first location and directing the autonomous vehicle to follow the route.

Example 3 provides a method according to one or more of the preceding examples, including determining a second location where there at least one on-road event is likely to occur, and wherein the route includes the second location.

Example 4 provides a method according to one or more of the preceding examples including when the autonomous vehicle has completed the route, directing the autonomous vehicle to repeat the route.

Example 5 provides a method according to one or more of the preceding examples wherein determining the first location and determining the timeframe include consulting a high fidelity map.

Example 6 provides a method according to one or more of the preceding examples including updating a high fidelity map with the encounters of the at least one on-road event.

Example 7 provides a method according to one or more of the preceding examples including reviewing the encounters of the at least one on-road event and determining whether the encounters indicate an improvement.

Example 8 provides a method according to one or more of the preceding examples including updating vehicle software when the encounters indicate an improvement.

Example 9 provides a method according to one or more of the preceding examples including recording a total number of encounters.

Example 10 provides a method according to one or more of the preceding examples including determining differences between the encounters.

Example 11 provides a system for autonomous vehicle testing, including a testing service for generating a test request including at least one on-road event; and a central computing system for receiving the test request, identifying a first location where the at least one on-road event is likely to occur, and dispatching at least one autonomous vehicle to perform the test request, wherein the at least one autonomous vehicle is directed to the first location.

Example 12 provides a system according to one or more of the preceding examples wherein the central computing system comprises a routing coordinator for generating a route for the at least one autonomous vehicle.

Example 13 provides a system according to one or more of the preceding examples wherein the generated route includes the first location.

Example 14 provides a system according to one or more of the preceding examples wherein the central computing system includes a 3-dimensional map, and the 3-dimensional map includes a layer indicating a likelihood of a future on-road event in areas in the 3-dimensional map.

Example 15 provides a system according to one or more of the preceding examples wherein the layer indicates timeframes for the likelihood of the future on-road events, wherein the likelihood varies in different timeframes.

Example 16 provides a system according to one or more of the preceding examples, wherein the central computing system receives feedback from the at least one autonomous vehicle including any encounters of the at least one on-road event.

Example 17 provides a method for updating map information, including collecting data from a plurality of autonomous vehicles, wherein the data includes a first set of on-road events, transmitting the data to a central computing system, wherein the central computing system includes a 3-dimensional map, and generating a layer of the 3-dimensional map including the data.

Example 18 provides a method according to one or more of the preceding examples, wherein collecting data includes identifying occurrences of on-road events in the first set of on-road events, and recording a location and a timeframe of each on-road event in the first set of on-road events.

Example 19 provides a method according to one or more of the preceding examples, wherein the timeframe includes a day of week and a time of the day.

Example 20 provides a method according to one or more of the preceding examples, wherein generating the layer of the 3-dimensional map includes indicating in the layer a likelihood of a future on-road event in areas in the 3-dimensional map.

### Variations and Implementations

According to various examples, driving behavior includes any information relating to how an autonomous vehicle drives. For example, driving behavior includes how and when the autonomous vehicle actuates its brakes and its accelerator, and how it steers. In particular, the autonomous vehicle is given a set of instructions (e.g., a route or plan), and the driving behavior determines how the set of instructions is implemented to drive the car to and from various destinations, and, potentially, to stop for passengers or items. Driving behavior may include a description of a controlled operation and movement of an autonomous vehicle and the manner in which the autonomous vehicle applies traffic rules during one or more driving sessions. Driving behavior may additionally or alternatively include any information about how an autonomous vehicle calculates routes (e.g., prioritizing fastest time vs. shortest distance), other autonomous vehicle actuation behavior (e.g., actuation of lights, windshield wipers, traction control settings, etc.) and/or how an autonomous vehicle responds to environmental stimulus (e.g., how an autonomous vehicle behaves if it is raining, or if an animal jumps in front of the vehicle). Some examples of elements that may contribute to driving behavior include acceleration constraints, deceleration constraints, speed constraints, steering constraints, suspension settings, routing preferences (e.g., scenic routes, faster routes, no highways), lighting preferences, “legal ambiguity” conduct (e.g., in a solid-green left turn situation, whether a vehicle pulls out into the intersection or waits at the intersection line), action profiles (e.g., how a vehicle turns, changes lanes, or performs a driving maneuver), and action frequency constraints (e.g., how often a vehicle changes lanes).

As will be appreciated by one skilled in the art, aspects of the present disclosure, in particular aspects of a perception system for an autonomous vehicle, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

What is claimed is:

1. A method for autonomous vehicle testing, comprising:
receiving a test request including at least one on-road event;
determining a first location where the at least one on-road event is likely to occur;
determining a timeframe during which the at least one on-road event is likely to occur at the first location;
dispatching an autonomous vehicle to the first location during the timeframe; and
recording any encounters of the at least one on-road event by the autonomous vehicle.

2. The method of claim 1, further comprising generating a route including the first location and directing the autonomous vehicle to follow the route.

3. The method of claim 2, determining a second location where there at least one on-road event is likely to occur, and wherein the route includes the second location.

4. The method of claim 2, further comprising, when the autonomous vehicle has completed the route, directing the autonomous vehicle to repeat the route.

5. The method of claim 1, wherein determining the first location and determining the timeframe include consulting a high fidelity map.

6. The method of claim 1, further comprising updating a high fidelity map with the encounters of the at least one on-road event.

7. The method of claim 1, further comprising reviewing the encounters of the at least one on-road event and determining whether the encounters indicate an improvement.

8. The method of claim 7, further comprising updating vehicle software when the encounters indicate an improvement.

9. The method of claim 1, further comprising recording a total number of encounters.

10. The method of claim 1, further comprising determining differences between the encounters.

11. A system for autonomous vehicle testing, comprising:
a testing service for generating a test request including at least one on-road event; and
a central computing system for receiving the test request, identifying a first location where the at least one on-road event is likely to occur, and dispatching at least one autonomous vehicle to perform the test request,
wherein the at least one autonomous vehicle is directed to the first location.

12. The system of claim 11, wherein the central computing system comprises a routing coordinator for generating a route for the at least one autonomous vehicle.

13. The system of claim 12, wherein the generated route includes the first location.

14. The system of claim 11, wherein the central computing system includes a 3-dimensional map, and the 3-dimensional map includes a layer indicating a likelihood of a future on-road event in areas in the 3-dimensional map.

15. The system of claim 14, wherein the layer indicates timeframes for the likelihood of the future on-road events, wherein the likelihood varies in different timeframes.

16. The system of claim 11, wherein the central computing system receives feedback from the at least one autonomous vehicle including any encounters of the at least one on-road event.

17. A method for updating map information, comprising:
collecting data from a plurality of autonomous vehicles, wherein the data includes a first set of on-road events;
transmitting the data to a central computing system, wherein the central computing system includes a map having a plurality of layers; and
generating a first layer of the map including the data.

18. The method of claim 17, wherein collecting data comprises:
identifying occurrences of on-road events in the first set of on-road events; and
recording a location and a timeframe of each on-road event in the first set of on-road events.

19. The method of claim 18, wherein the timeframe includes a day of week and a time of the day.

20. The method of claim 19, wherein generating the first layer of the map includes indicating in the first layer a likelihood of a future on-road event in areas in the map.
